(19) United States
(12) Patent Application Publication
(10) Pub. No.: US 2002/0165297 A1
(43) Pub. Date: Nov. 7, 2002

(54) Polymeric resins impregnated with insect repellants

(75) Inventor: Eric Albee, Shamong, NJ (US)

Correspondence Address: BRUCE E. LILLING, LILLING & LILLING P.C., P.O. BOX 560, GOLDEN BRIDGE, NY, 10526, US

(73) Assignee: The 54 Group, Ltd., Scarsdale, NY

(21) Appl. No.: 10/058,573

(22) Filed: Jan. 28, 2002

Related U.S. Application Data
(60) Provisional application No. 60/266,486, filed on Feb. 2, 2001.

(51) Int. Cl. C08L 97/00

(52) U.S. Cl. 524/78; 524/481; 524/512; 524/75; 524/81

(57) ABSTRACT

The present invention relates to polymeric resins that have been impregnated with insect repellents and methods for making same. In particular, the insect repellents contain citronella oil and d-limonene. Additionally, the present invention relates to products formed from insect repellent impregnated polymeric resins and methods for making same. Preferred products such as, for example, plastic tablecloths, plastic garbage receptacles and plastic garbage/lawn bags are described.

### TECHNICAL FIELD

The present invention relates to polymeric resins that have been impregnated with insect repellents and methods for making same. In particular, the insect repellents contain citronella oil and d-limonene. Additionally, the present invention relates to products formed from impregnated polymeric resins and methods for making same. Preferred products such as, for example, plastic tablecloths, plastic garbage receptacles and plastic garbage/lawn bags are described.

### BACKGROUND OF THE INVENTION

It is known that plastics may be impregnated with various chemical compositions, such that the chemical compositions are slowly released from the impregnated plastics. Such impregnated plastics have been used to form antibiotic impregnated medical devices that serve to prevent infection, dry leaning solvent impregnated devices for home dryer dry cleaning and insecticide impregnated polymeric foams for use as building materials.

German Patent 2,320,373 discloses an antibiotic containing agent, which has a spherical shape and wherein the antibiotic is evenly distributed in the plastic material. The spheres described are preferably connected with a thread or wire and can be used, for example, to fill osteomyelitic cavities.

U.S. Pat. 4,542,162 discloses a process for preparing foamed, thermoplastic particles which contain insect, animal or bird repellent fluid. The insect, animal or bird repellent may be present from about 1% to about 45% by weight of the resin. Use of a foaming agent is required to prevent “oiling out” of the insect, animal or bird repellent (Col. 8, lines 26-28). This patent further discloses that the insect repellents useful in forming the foamed, thermoplastic particles are disclosed in U.S. Pat. No. 4,449,987.

U.S. Pat. No. 4,994,499 discloses a process for preparing polymer beads that incorporate both a bowing agent and a flame retardant.

U.S. Pat. No. 5,165,952 discloses a plastic medical article that is impregnated with up to 10% chlorohexidine. The medical articles were prepared by twin screw compounding followed by extrusion of the impregnated melt. Further, this patent teaches that polyurethanes, polyurethanesureas and siloxane urethane polymers are suitable for impregnation followed by extrusion.

U.S. Pat. No. 5,489,286 discloses a polymeric, tympanic ventilation tube, which includes a pair of flanges disposed at opposite ends of a tubular member. At least one of the tubular member or the flanges is impregnated with an antibiotic. Preferably, the antibiotic is from the amino glycocide family.

U.S. Pat. No. 5,876,462 discloses a home dryer dry cleaning system and process which contains a containment bag, dispenser means and an absorbent polymeric material. The dispenser means is preferably a porous polymeric material, which is impregnated with a liquid cleaning composition. Typical cleaning compositions contain one or more solvents as well as one or more surfactants. -Preferred polymeric materials for the dispensing means are polyalkylenes such as, for example, polyethylene and polybutylene.

U.S. Pat. No. 6,033,731 discloses polymers of vinyl aromatic monomers, which may incorporate blowing agents, insecticides and flame retardants. The insecticide may be present in the polymeric resin from 0.01% to 1% by weight of the resin (Col. 2, lines 58-62).

The specifications of the documents disclosed in this application are incorporated by reference herein.

Thus there exists a need for a polymeric resins that have been impregnated with insect repellents, which can be impregnated with up to 25% by weight of an insect repellent that don't suffer from oiling out without the use of an additional foaming agent. Further, there exists a need for products manufactured from polymeric resins that have been impregnated with up to 25% by weight of an insect repellent that provide an essentially steady state or zero order sustained release of the insect repellent without suffering from oiling out.

### SUMMARY OF THE INVENTION

One aspect of the present invention relates to polymeric resins that have been impregnated with insect repellents and methods for making same. The resins of the present invention are prepared by introducing the polymeric resin into the extruder barrel of either a single screw or twin screw extruder and melting the polymeric resin prior to the introduction of the insect repellent. The resulting melted mixture of polymeric resin and insect repellent is homogeneously and uniformly mixed before exiting the extruder. Upon exiting the extruder the mixture is pelletized using a pelletizer. The finished pellets may then be packaged for shipment of used directly in the manufacture of any product that incorporates the insect repellent impregnated polymeric resins.

A further aspect of the present invention is articles of manufacture that incorporate the insect impregnated polymeric resins of the present invention. Many products manufactured from polymeric resins such as, for example, plastic tablecloths, plastic garbage receptacles and plastic garbage/lawn bags will be significantly improved by the incorporation of an insect repellent that is released in a steady state or zero order manner for a sustained period of time.

### DETAILED DESCRIPTION OF THE INVENTION

The nature of the extruder utilized in the process of the present invention to form the polymeric resins impregnated with insect repellent of the present invention may be either single screw or double screw. Thus, the types of extruders that can be used are disclosed at pages 246-267 and 332-349 of the Modem Plastics Encyclopedia, 1982-1983 published by the McGraw-Hill Publishing Company, the disclosure of which is incorporated by reference herein. More specifically, examples of extruders which are usable in carrying out the process of the invention (with modification for introduction of insect repellent downstream from introduction of the polymer are as follows:

1. The Welex “Super Twinch” 3.5extruder manufactured by Welex Incorporated, 850 Jolly Road, Blue Bell, Pa. 19422

2. Krauss-Maffei twin screw extruder manufactured by the Krauss-Maffei Corporation/Extruder Division, 3629 West 30th Street South, Wichita, Kans. 67277

3. Modified Sterling model 4000 and 5000 series extruder manufactured by Sterling Extruder Corporation of 901 Durham Avenue, South Plainfield, N.J.

4. CRT (“Counter-Rotating Tangential”) Twin Screw Extruder manufactured by Welding Engineers, Inc. of King of Prussia, Pa. 19406

5. The Leistritz Twin Screw Dispersion Compounder manufactured by the American Leistritz Extruder Corporation of 198 U.S. Route 206 South, Somerville, N.J. 08876

6. The ZSK Twin Screw Co-Rotating Extruder manufactured by the Werner & Pfleiderer Corporation of 663 East Crescent Avenue, Ramsey, N.J. 07446

7. The Farrel Extruder manufactured by Farrel Connecticut Division, Emhart Machinery Group, Ansonia, CN. 06401

8. The MPCN Baker Perkins Twin Screw Extruder manufactured by the Baker Perkins Inc. Chemical Machinery Division of Saginaw, Mich. 48601

9. The Berstorff single screw, twin screw, or foam extrusion equipment manufactured by Berstorff Corporation, P.O. Box 240357, 8200-A Arrowridge Blvd., Charlotte, N.C. 28224

In producing the polymeric resins impregnated with insect repellent of the present invention, various polymers may be utilized such as, for example, low density polyethylene, high density polyethylene and polypropylene. Specific example of polymers useful in the practice of the present invention are as follows:

(a) DYLAN.RTM. brand of low density polyethylene (DYLAN.RTM. is a trademark owned by the Atlantic Richfield Company of Los Angeles, Calif.

(b) DYLITE.RTM. brand of expandable polystyrene compositions. DYLITE.RTM. is a trademark of the Atlantic Richfield Company of Los Angeles, Calif.

(c) SUPER DYLAN.RTM. brand of high density polyethylene. SUPER DYLAN.RTM. is a trademark of the Atlantic Richfield Company of Los Angeles, Calif.

(d) Blended polyethylene and carbon black as specifically taught in U.S. Pat. No. 4,369,267 issued on Jan. 18, 1983, the specification for which is incorporated by reference herein.

(e) Polystyrene as disclosed in U.S. Pat. No. 4,369,227 issued on Jan. 18, 1983, the specification for which is incorporated by reference herein.

(f) Polyene/alpha-olefin copolymers as exemplified and disclosed in U.S. Pat. No. 4,369,291, the specification for which is incorporated by reference herein.

(g) Poly-alpha-olefins as exemplified in Canadian Pat. No. 1,137,069 issued on Dec. 7, 1982, the specification for which is incorporated by reference herein.

(h) Polymeric compositions as disclosed in Canadian Pat. No. 1,137,068 issued on Dec. 7, 1982, the specification for which is incorporated by reference herein.

(i) Poly-alpha-olefins disclosed in Canadian Pat. No 1,137,067, the specification for which is incorporated by reference herein.

(j) Polyolefins described in Canadian Pat. No. 1,137,066, the specification for which is incorporated by reference herein.

(k) Polyethylene oxides as disclosed in Canadian Pat. No. 1,137,065 issued on Dec. 7, 1982, the specification for which is incorporated by reference herein.

(l) Olefin polymers and co-polymers as disclosed in Canadian Pat. No. 1,139,737, the disclosure of which is incorporated by reference herein. Canadian Pat. No. 1,139,737 was issued on Jan. 18, 1983.

(m) Polyolefins disclosed in Canadian Pat. No. 1,139,738, the specification for which is incorporated by reference herein. Canadian Pat. No. 1,139,738 was issued on Jan. 18, 1983.

(n) Chlorinated PVC as disclosed in Polymer 1982, 23 (7, Suppl.), 1051-6 abstracted at Chem. Abstracts 97:145570y, 1982.

(o) Polyepsilon caprolactone co-polymers made by means of alcohol initiated polymerization as disclosed in J. Polym. Sci. Polym. Chem. Ed. 1982,20(2), pages 319-26, abstracted at Chem. Abstracts, Volume 96: 123625x, 1982.

(p) Styrene acrylonitrile co-polymers as disclosed in Diss., Abstracts, Int. B, 1982, 42(8), 3346 and abstracted at Chem. Abstracts 96:143750n (1982).

(q) Co-polymers of epsilon caprolactone with 1,4-butane diol as disclosed at Kauch. Rezine, 1982, (2), 8-9, abstracted at Chem. Abstracts, Volume 96:182506g (1982).

(r) Polyesters as disclosed in U.S. Pat No. 4,326,010, the specification for which is incorporated by reference herein.

(s) Chlorinated polyethylene as disclosed by Belorgey, et al. J. Polym. Sci. Polym. Phys. Ed. 1982,20(2), 191-203.

(t) Plasticized polyepsilon caprolactone co-polymers containing dimethyl phthalate plasticizers as set forth in Japanese Pat. No. J81/147844, abstracted at Chem. Abstracts, Volume 96:69984y (1982), the specification for which is incorporated by reference herein.

(u) Maleic anhydride modified adducts of polyepsilon caprolactone polyols and ethylenically unsaturated monomer as disclosed in U.S. Pat. No. 4,137,279 issued on Jan. 30, 1979, the specification for which is incorporated by reference herein.

(v) Polyurethane polymers having lactone backbones as disclosed in U.S. Pat. No. 4,156,067 issued on May 22, 1979, the disclosure of which is incorporated by reference herein.

(w) Polyurethane polyether resins wherein the resin is obtained by reacting a polyfunctional lactone with a long chain polyalkylene diol and a urethane precursor as disclosed in U.S. Pat. No. 4,355,550 issued on Mar. 10, 1981, the disclosure of which is incorporated by reference herein.

(x) Resins having polyurethane backbones as disclosed in U.S. Pat. No. 3,975,350 issued on Aug. 17, 1976, the disclosure of which is incorporated by reference herein.

Additionally, the polymers used in the practice of the invention may be co-polymers such as, for example, vinyl chloride or ethylene co-polymerized with a polar vinyl monomer selected from (a) vinyl acetate; (b) ethyl acrylate; (c) methyl acrylate; (d) butyl acrylate and (e) acrylic acid including the hydrolyzed co-polymer of ethylene and vinyl acetate. Specific example of co-polymers, which are available in the molding powder form, useful in the practice of the present invention are as follows:

(a) Ethylene vinyl acetate co-polymers marketed by the E.I. duPont de Nemours Company under the trade name “ELVAX.RTM.” and by the Arco Polymer Division under the trademark “DYLAND.RTM.” and by the Exxon Corporation of Linden, N.J. under the trademark “DEXXON.RTM.”.

(b) Ethylene/ethyl acrylate co-polymers marketed by Union Carbide Corporation under the trade name “EEA RESINS.RTM.”.

The present invention provides a process for forming polymeric resins impregnated with a relatively high concentration of insect repellent. The insect repellent added downstream of a reference barrel segment of the single screw or twin screw extruder must be previously compatible with or made to be compatible with the polymer added at the reference barrel segment of the single screw or twin screw extruder.

The proportion of insect repellent added to the polymeric resin can vary from small but effective amounts on the order of about 1% of the weight of the resin up to about 25% by weight of the resin. There is an optimum amount balancing the proportion of insect repellent in the product against the time period over which the polymeric resin emits the insect repellent in a steady state or zero order manner.

The nature of the insect repellent added to the polymeric resin will vary for the intended end use of the pellets formed by the extrusion process. Such insect repellents are set forth below and in U.S. Provisional Patent Application No. 60/209,346, the specification of which is incorporated by reference herein.

The insect repellents useful in the practice of the present invention comprise mixtures of citronella oil, geranium oil, rosemary oil and peppermint oil, as well as additional fragrances and diluents. Preferred insect repellents useful in the practice of the present invention further comprise D-limonene; aldehyde C-14; and aldehyde C-18. A specific example of an insect repellent useful in the practice of this invention, which is not to be considered limiting, is described in Table 1.

TABLE 1

| Component | Weight Percent |
|---|---|
| citronella oil | 3.25 |
| d-limonene | 4.54 |
| aldehyde C-14 | 0.40 |
| aldehyde C-18 | 0.39 |
| lavender oil | 4.17 |
| spearmint oil | 3.47 |
| peppermint oil | 1.16 |
| iso-bomyl acetate | 0.95 |
| geranium oil | 4.16 |
| vanillin | 1.40 |
| anethole | 0.29 |
| heliotropine | 0.29 |
| pine needle oil | 2.24 |
| aldehyde C-10 | 0.59 |
| lynalool | 2.68 |
| rosemary oil | 0.76 |
| citral | 1.13 |
| piperitone | 0.10 |
| lemon oil | 4.39 |
| grapefruit oil | 4.46 |
| N-amyl alcohol | 0.06 |
| lavandin oil | 8.58 |
| spike lavander | 2.19 |
| oil petitgrain mandarin | 1.50 |
| eucalyptus oil | 0.31 |
| orange terpens | 46.34 |
| neroli oil | 0.20 |

The polymer chosen for the preparation of the impregnated polymeric resins of the present invention is loaded into the single screw or twin screw extruder at a feed rate in the range of from about 80 up to about 300 pounds per hour while maintaining the temperature in the screw extruder between about 160° C. and about 240° C. The polymer or co-polymer powder is added to the extruder at a reference barrel segment and the insect repellent is added to the extruder under pressure downstream from the addition point of the polymer.

The resulting mixture of polymer and insect repellent is homogenously and uniformly mixed before being extruded. The die of the extruder may create rods, sheets, films, ribbons or any other geometric shape known to one of skill in the art. The extruded product is preferably pelletized using a pelletizer. Specific examples of pelletizers are strand pelletizers, die face under water pelletizers and die face dry cut pelletizers.

The resulting extrudate, which is preferably in the form of pellets, is either packaged for shipment or used directly to manufacture and end-use product such as, for example, plastic tablecloths, plastic garbage receptacles and plastic garbagelawn bags. Such end-use products may be formed by any method known to one of skill in the art such as, for example, extrusion or injection molding. Such injection molding can be carried out in accordance with the procedure as set forth in U.S. Pat. No. 3,268,636, the specification for which is incorporated by reference herein.

From the foregoing description, one of ordinary skill in the art can easily ascertain the essential characteristics of this invention and, without departing from its spirit or scope, can make various changes and modifications in the invention to adapt it to various usages and conditions.

1. An insect repellent containing polymeric resin, comprising:
a polymer or co-polymer; and
an insect repellent, wherein the insect repellent is homogenously and uniformly mixed throughout the polymeric resin.

2. The insect repellent containing polymeric resin according to claim 1, wherein the insect repellent is present in an amount up to about 25% by weight of the polymeric resin.

3. The insect repellent containing polymeric resin according to claim 2, wherein the polymer is a polyalkylene.

4. The insect repellent containing polymeric resin according to claim 3, wherein the polymer is selected from the group consisting of low density polyethylene, very low density polyethylene, linear low density polyethylene and high density polyethylene.

5. The insect repellent containing polymeric resin according to claim 2, wherein at least one of the monomers of the co-polymer is a polyalkylene.

6. The insect repellent containing polymeric resin according to claim 5, wherein at least one of the monomers is polyvinylchloride.

7. The insect repellent containing polymeric resin according to claim 1, wherein the insect repellent, comprises: citronella oil; geranium oil; rosemary oil; and peppermint oil.

8. The insect repellent containing polymeric resin according to claim 7, wherein the insect repellent further comprises: D-limonene; aldehyde C-14; and aldehyde C-18.

9. The insect repellent containing polymeric resin according to claim 8, wherein the insect repellent further comprises lavender oil.

10. The insect repellent containing polymeric resin according to claim 9, wherein the insect repellent further comprises piperitone.

11. The insect repellent containing polymeric resin according to claim 10, wherein the insect repellent further comprises eucalyptus oil.

12. The insect repellent containing polymeric resin according to claim 11, wherein the insect repellent further comprises at least one fragrance compound.

13. The insect repellent containing polymeric resin according to claim 12, wherein the fragrance compounds are selected from the group consisting of spearmint oil, iso-bornyl acetate, vanillin, anethole, heliotropine, pine needle oil, aldehyde-C-10, lynalool, citral, lemon oil, grapefruit oil, N-amyl alcohol, lavandin oil, spike lavander, oil petitgrain mandarin, orange terpens and neroli oil.

14. A process for preparing an insect repellent containing polymeric resin, comprising the following steps:
loading a polymer or co-polymer into a single screw or twin screw extruder;
melting the polymer or co-polymer in the single screw or twin screw extruder;
adding an insect repellent into the extruder at a point downstream from the point where the polymer or co-polymer is loaded into the extruder;
mixing the polymer or co-polymer and the insect repellent such that a homogenous and uniform mixture is obtained; and
extruding the insect repellent containing polymeric resin from the extruder.

15. The process according to claim 14, wherein the polymer or co-polymer is loaded into the single screw or twin screw extruder at a feed rate of from about 80 up to about 300 pounds per hour.

16. The process according to claim 15, wherein the temperature in the single screw or twin screw extruder is maintained between about 160° C. and about 240° C.

17. The process according to claim 14, wherein the insect repellent is present in an amount up to about 25% by weight of the polymeric resin.

18. The process according to claim 14, wherein the polymer is a polyalkylene.

19. The process according to claim 18, wherein the polymer is selected from the group consisting of low density polyethylene, very low density polyethylene, linear low density polyethylene and high density polyethylene.

20. The process according to claim 14, wherein at least one of the monomers of the co-polymer is a polyalkylene.

21. The process according to claim 20, wherein at least one of the monomers is polyvinylchloride.

22. The process according to claim 14, wherein the insect repellent, comprises: citronella oil; geranium oil; rosemary oil; and peppermint oil.

23. The process according to claim 22, wherein the insect repellent further comprises: D-limonene; aldehyde C-14; and aldehyde C-18.

24. The process according to claim 23, wherein the insect repellent further comprises lavender oil.

25. The process according to claim 24, wherein the insect repellent further comprises piperitone.

26. The process according to claim 25, wherein the insect repellent further comprises eucalyptus oil.

27. The process according to claim 26, wherein the insect repellent further comprises at least one fragrance compound.

28. The process according to claim 27, wherein the fragrance compounds are selected from the group consisting of spearmint oil, iso-bornyl acetate, vanillin, anethole, heliotropine, pine needle oil, aldehyde-C-10, lynalool, citral, lemon oil, grapefruit oil, N-amyl alcohol, lavandin oil, spike lavander, oil petitgrain mandarin, orange terpens and neroli oil.

29. The process according to claim 14, wherein the extruded polymeric resin is pelletized with a pelletizer.

30. The process according to claim 29, wherein the pelletizer is selected from the group consisting of strand pelletizers, die face under water pelletizers and die face dry cut pelletizers.

31. A product exhibiting steady state or zero order release of an insect repellent, comprising:
an article consisting of an insect repellent containing polymeric resin, wherein the insect repellent is homogenously and uniformly distributed throughout the product.

32. The product according to claim 31, wherein the article consists of a mixture a polymer or co-polymer and the insect repellent containing polymeric resin, wherein the insect repellent is homogenously and uniformly distributed throughout the product.

33. The product according to any one of claims 31 or 32, wherein the product is prepared by extrusion or injection molding.

34. The product according to claim 33, wherein the product is prepared by extrusion.

35. The product according to claim 34, wherein the product is selected from the group consisting of plastic tablecloths and plastic garbage/lawn bags.

36. The product according to claim 33, wherein the product is prepared by injection molding.

37. The product according to claim 36, wherein the product is a plastic garbage receptacle.
